(19) United States
(12) Patent Application Publication
(10) Pub. No.: US 2012/0100946 A1
(43) Pub. Date: Apr. 26, 2012

(54) CHAIN

(75) Inventor: Tetsuji Kotera, Mie (JP)

(73) Assignee: BorgWarner Inc., Auburn Hills, MI (US)

(21) Appl. No.: 13/379,389

(22) PCT Filed: Jun. 29, 2010
(86) PCT No.: PCT/US2010/040288

§ 371 Date: Dec. 20, 2011

(30) Foreign Application Priority Data
Jun. 30, 2009 (JP) 2009-155037

(51) Int. Cl. F16G 13/06

(52) U.S. Cl. 474/206

(57) ABSTRACT

To provide a chain having a mechanism for preventing backbend which does not cause any reduction in power transmission efficiency when the chain is operating, which can suppress string vibration in the chain spans, and which is highly durable. A mechanism for preventing backbend is provided, in the chain length direction, with a plurality of spring washer structures (5) consisting of a pair of left-right spring washer parts (50, 51) which have linking pins (3) inserted therein, and linking bars (55) for linking the areas between the spring washer parts (50, 51); and adjacent spring washer structures (5) in the chain length direction extend in the length direction of the chain in a state in which the spring washer parts (50, 51) of each are overlapping. When link plates (2) undergo backbend, the spring washer structures (5) flex together with the link plates (2), and the mutual rotation of the spring washer parts (50, 51) causes an increase in the thickness of the spring washer structures (5).

### TECHNICAL FIELD

The present invention relates to a chain provided with a mechanism for preventing backbend in order to regulate string vibration in the chain spans, and more specifically the invention relates to an improved structure for said backbend prevention mechanism.

### PRIOR ART

Silent chains or roller chains, for example, are used as power transmission chains and timing chains in automobiles and motorcycles etc. These chains generally have a configuration in which a large number of links comprising respective pairs of pin holes are respectively linked in such a way as to be able to flex about one another by linking pins which are inserted into each pin hole.

When these kinds of chains are wound onto a drive sprocket and a driven sprocket and rotated, a tension side span and a slack side span are formed in the area between the sprockets where the chain is disposed, but when the chain is operating, resonance is produced on the tension side span of the chain at a specific engine speed corresponding to the natural vibration of the chain, causing noise during operation. When this resonance occurs, the tension side span of the chain undergoes string vibration, and so the links of the chain flex not only toward the sprocket meshing side, but also toward the back side opposite thereto.

In order to prevent string vibration on the tension side span of the chain. Japanese Unexamined Patent Application Publication H8-74939 proposes the use of a system in which wave-shaped spring links are held in a compressed manner between adjacent links in the width direction of the chain (see FIGS. 2 and 4 of that publication). It should be noted that the same example is disclosed in FIG. 2 of Japanese Unexamined Patent Application Publication H10-54445, and in FIGS. 1, 4, and 8 of Japanese Unexamined Patent Application Publication 2000-130518.

By installing spring links in the chain, the elastic repelling force accompanying the compressive deformation of the spring links acts between adjacent links in the width direction of the chain so that a friction force is applied between links, thereby increasing the bending resistance of the chain and suppressing string vibration in the chain spans.

However, in this case, the elastic repelling force produced by the compressive deformation of the spring links constantly acts within the chain when the chain is operating, and therefore the bending resistance of the chain is also increased when the chain meshes with the sprockets as the chain transmits power. As a result, friction loss is produced when the chain meshes, which leads to reductions in the power transmission efficiency of the chain.

In order to prevent string vibration in the chain spans without reducing the power transmission efficiency, a chain has been proposed such as that of Japanese Unexamined Patent Application Publication 2004-28154 (see FIGS. 2, 5, and 6 of that publication).

In order to suppress flexing of the links toward the hack (backbend) in that chain, protrusions which cause interference with the shoulder parts of the links when said links undergo backbend are formed on links adjacent to said links in the width direction of the chain.

In this case, when string vibration occurs in the chain spans and the chain is made to flex back, the protrusions interfere with the shoulder parts of the links, whereby the flexing motion of the links toward the back is restricted, and as a result, the string vibration in the chain spans can be made into a substantially pulsating state, making it possible to suppress string vibration in the chain spans. Moreover, in this case, the flexing motion of the links is not inhibited when the chain meshes, and therefore there is no reduction in power transmission efficiency when the chain is operating.

### SUMMARY OF THE INVENTION

### Issues to be Resolved by the Invention

However, when there is friction between the pins and pin holes of the links during operation of the chain in the conventional structure described above, the distance between the shoulder parts of the links and the protrusions increases. When this happens, the protrusions cannot provide adequate interference with the shoulder parts of the links, and as a result the flexing motion of the links toward the back is not adequately restricted. This means that this conventional structure is not very durable.

The present invention has been devised in view of the situation outlined above, and the issue addressed by the present invention lies in providing a chain having a mechanism for preventing backbend which does not cause any reduction in power transmission efficiency when the chain is operating, which can suppress string vibration in the chain spans, and which is highly durable.

### Means of Resolving the Issues

The invention disclosed in claim 1 is a chain in which a plurality of links having respective pairs of pin holes are disposed in the length direction and the thickness direction, and the links are linked in such a way as to be able to flex about one another by linking pins which are inserted into the pin holes, wherein a mechanism for preventing backbend is provided between any adjacent links in the thickness direction. The backbend prevention mechanism is provided, in the chain length direction, with a plurality of spring washer structures consisting of a pair of left-right spring washer parts which are disposed with an interval therebetween and have the linking pins inserted therein, and linking parts for linking the areas between the spring washer parts; and adjacent spring washer structures in the chain length direction extend in the length direction of the chain in a state in which the spring washer parts of each are overlapping.

According to the invention disclosed in claim 1, when the links of the chain undergo backbend, the links flex, and adjacent spring washer structures in the chain length direction also flex, and at this point, the overlapping spring washer parts of the spring washer structures mutually rotate, causing an increase in the thickness of the overlapping portions of the spring washer parts.

This means that a friction force acts between adjacent links in the chain width direction, increasing the bending resistance of the chain, and backbend of the links can be suppressed; as a result, it is possible to suppress string vibration in the chain spans.

Furthermore, in this case, when the links flex toward the meshing side with the sprocket, if the overlapping spring washer parts mutually rotate in the opposite direction to when the links undergo backbend, the thickness of the overlapping portions of the spring washer parts does not increase because of the twisted structure of the spring washer parts.

Consequently, when the chain meshes, there is no increase in the bending resistance of the chain, which means that the power transmission efficiency of the chain is not reduced during operation.

Moreover, in this case, even if the friction between the linking pins and pin holes causes elongation of the chain during operation, the linking pins are always inserted in the spring washer parts of the spring washer structures, and the overlapping spring washer parts of adjacent spring washer structures in the chain length direction always mutually rotate together with the links when said links undergo backbend, thereby causing an increase in the thickness of the spring washer parts.

Consequently, the backbend prevention mechanism according to claim 1 is unaffected by chain friction, and is very durable.

In the invention disclosed in claim 2, which is in accordance with the invention of claim 1, the spring washer parts are formed as coil shapes twisted by one turn, and a slit is formed between the starting edge and ending edge of said twisted coil shapes of the spring washer parts.

In this case, the spring washer parts have a twisted coil shape, and so when the overlapping spring washer parts rotate in the same direction as when the links undergo backbend, the thickness of the overlapping portions of the spring washer parts increases; if the spring washer parts rotate in the opposite direction to when the links undergo backbend, the thickness of the overlapping portions of the spring washer parts decreases.

In the invention disclosed in claim 3, which is in accordance with the invention of claim 2, the starting edge of one of the overlapping spring washer parts is disposed opposite the ending edge of the other spring washer part.

In this case, it is possible to reduce the thickness of the overlapping portions of the spring washer parts, which makes it possible to restrict increases in the chain width caused by assembling the spring washer structures therewith.

In the invention disclosed in claim 4, which is in accordance with claim 2, the position of the slits is offset from a straight line which is orthogonal to the center line linking the centers of each of the spring washer parts and which passes through the centers thereof.

In this case, the slits in the overlapping spring washer parts may be offset from each other when the chain extends in a straight line, which means that when the links flex toward both the sprocket meshing side and the backbend side, the spring washer parts can smoothly mutually rotate toward either side, and there is no impediment to the flexing of the links.

In the invention disclosed in claim 5, which is in accordance with claim 2, the slit in one of the overlapping spring washer parts is offset from the slit in the other spring washer part.

In this case, when the links flex toward both the sprocket meshing side and the backbend side, the spring washer parts can smoothly mutually rotate toward either side, and there is no impediment to the flexing of the links.

In the invention disclosed in claim 6, which is in accordance with claim 1, the spring washer structures are linked by means of the linking parts in a state in which the spring washer parts are disposed with a difference in level in the axial direction.

In this case, the spring washer parts of the spring washer structures can be reliably brought into contact with the adjacent links in the chain width direction.

In the invention disclosed in claim 7, which is in accordance with the invention of claim 6, the adjacent spring washer structures in the chain length direction are such that the spring washer part in the upper position of one of the spring washer structures is disposed above the spring washer part in the lower position of the other spring washer structure.

In this case, when the spring washer structures extend in the length direction of the chain, the thickness of the spring washer structures can be reduced, which makes it possible to restrict increases in the chain width caused by assembling the spring washer structures therewith.

In the invention disclosed in claim 8, which is in accordance with the invention of claim 1, the linking pins are round pins.

In the invention disclosed in claim 9, which is in accordance with the invention of claim 1, the linking pins constitute rocker joints comprising a pair consisting of a long and short joint pin and rocker pin, and when the links undergo backbend, the rocker joints press against the inner peripheral surface of the pin hole, providing interference, in order to suppress backbend of the links.

In this case, not only is the backbend preventing action produced by the spring washer structures exerted when the links undergo backbend, a further backbend preventing action is exerted by the rocker joints and the pin holes, and therefore it is possible to prevent backbend even more reliably.

The chain according to the present invention may be any of the silent chain disclosed in claim 10, or the roller chain or bush chain disclosed in claim 11.

### ADVANTAGES OF THE INVENTION

According to the present invention described above, the chain is provided with a backbend prevention mechanism in which a plurality of spring washer structures, consisting of a pair of left-right spring washer parts into which the linking pins are inserted, and linking parts for linking the areas between the spring washer parts, are disposed in the length direction of the chain, while adjacent spring washer structures in the chain length direction extend in the length direction of the chain in a state in which the spring washer parts of each are overlapping, and therefore when the chain links undergo backbend, the adjacent spring washer structures in the chain length direction flex as the links flex, and at this point the mutual rotation of the overlapping spring washer parts of the spring washer structures causes an increase in the thickness of the overlapping portions of the spring washer parts. This means that a friction force acts between adjacent links in the chain width direction, increasing the bending resistance of the chain, and backbend of the links can be suppressed, so it is possible to suppress string vibration in the chain spans.

Furthermore, in this case, when the links flex toward the meshing side with the sprocket, if the overlapping spring washer parts mutually rotate in the opposite direction to when the links undergo backbend, the thickness of the overlapping portions of the spring washer parts does not increase because of the twisted structure of the spring washer parts, and therefore when the chain meshes, there is no increase in the bending resistance of the chain, which means that it is possible to prevent a reduction in the power transmission efficiency of the chain during operation.

Moreover, in this case, even if the friction between the linking pins and pin holes causes elongation of the chain during operation, the linking pins are always inserted in the spring washer parts of the spring washer structures, and therefore the overlapping spring washer parts of adjacent spring washer structures in the chain length direction mutually rotate together with the links when said links undergo backbend, thereby causing an increase in the thickness of the overlapping portions of the spring washer parts. In this way, the backbend prevention mechanism is unaffected by chain friction, and is very durable.

### BRIEF DESCRIPTION OF THE FIGURES

FIG. 1 is a partial cross-sectional view in the length direction, in which a silent chain provided with the backbend prevention mechanism according to an exemplary embodiment of the present invention extends in a straight line, and corresponds to a cross section along the line I-I in FIG. 2.

FIG. 2 is a partial bottom view in which the silent chain in FIG. 1 is seen from the link tooth side.

FIG. 3 (a) is a front view of a spring washer structure which constitutes the backbend prevention mechanism shown in FIG. 1; and (b) is a side view thereof.

FIG. 4 (a) is a front view showing a state in which three of the spring washer structures shown in FIG. 3 extend in the length direction; and (b) is a side view thereof

FIG. 5 illustrates the function of the spring washer, where (a) shows the state before loading; and (b) shows the state after loading.

FIG. 6 illustrates the working principle behind the spring washer structure according to the present invention, where (a) shows the state of the overlapping spring washers before mutual rotation; and (b) shows the state of the spring washers after mutual rotation.

FIG. 7 shows the state when the silent chain in FIG. 1 meshes with the sprocket, and corresponds to a cross section along the line VII-VII in FIG. 8.

FIG. 8 is a partial bottom view in which the silent chain in FIG. 7 is seen from the link tooth side.

FIG. 9 shows the state of the silent chain shown in FIG. 1 when it is undergoing backbend, and corresponds to a cross section along the line IX-IX in FIG. 10.

FIG. 10 is a partial bottom view in which the silent chain in FIG. 9 is seen from the link tooth side.

FIG. 11 indicates further points for improvement in the silent chain of FIG. 1.

FIG. 12 shows a silent chain in which the points for improvement in FIG. 11 have been adopted.

FIG. 13 is an enlarged view showing the points for improvement in FIG. 12.

FIG. 14 is a partial cross-sectional view in the length direction of a silent chain according to another exemplary embodiment of the present invention, showing a state in which a silent chain which employs rocker joints as the linking pins extends in a straight line; this figure corresponds to FIG. 1 of the exemplary embodiment.

FIG. 15 shows the state when the silent chain in FIG. 14 meshes with the sprocket.

FIG. 16 shows the state of the silent chain in FIG. 14 when it is undergoing backbend.

### MODE OF EMBODIMENT OF THE INVENTION

Exemplary embodiments of the present invention will be described below based on the appended figures.

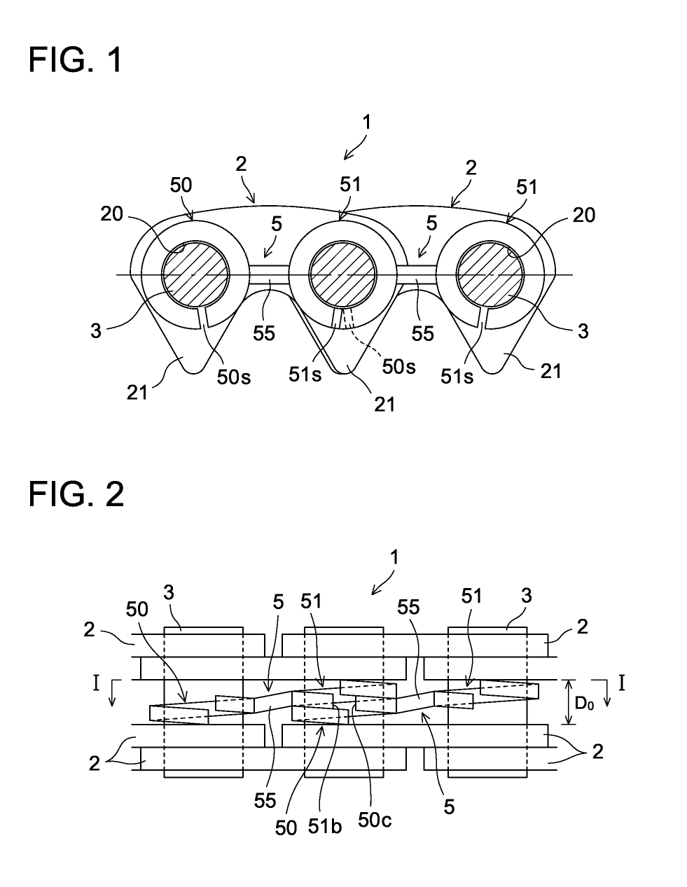

FIGS. 1 to 10 illustrate a silent chain according to one exemplary embodiment of the present invention, and components in these figures which are the same or corresponding bear the same reference symbols.

As shown in FIGS. 1 and 2, a silent chain 1 has a structure in which a large number of link plates 2 having respective pairs of pin holes 20 and tooth parts 21 are stacked in the length direction of the chain (the left-right direction in FIGS. 1 and 2) and the width direction of the chain (the direction perpendicular to the page in FIG. 1; the vertical direction in FIG. 2), and these link plates 2 are linked in such a way as to be able to flex about one another by linking pins 3 which are inserted into the pin holes 20.

A plurality of spring washer structures 5 which serve as the backbend prevention mechanism are provided in the chain length direction between any of the adjacent link plates 2 in the chain width direction. The spring washer structures 5 consist of a pair of left-right spring washer parts 50, 51 which are disposed with an interval therebetween and have the linking pins 3 inserted therein, and linking bars (linking parts) 55 for linking the areas between the spring washer parts 50, 51. Adjacent spring washer structures 5 in the chain length direction extend in the length direction of the chain, while being linked by means of the linking pins 3 in a state in which the spring washer parts 50, 51 of each are overlapping (see FIGS. 4(a) and (b)). Furthermore, at this point, the thickness of the overlapping portions of the spring washer parts 50, 51 is D₀, as shown in FIG. 2.

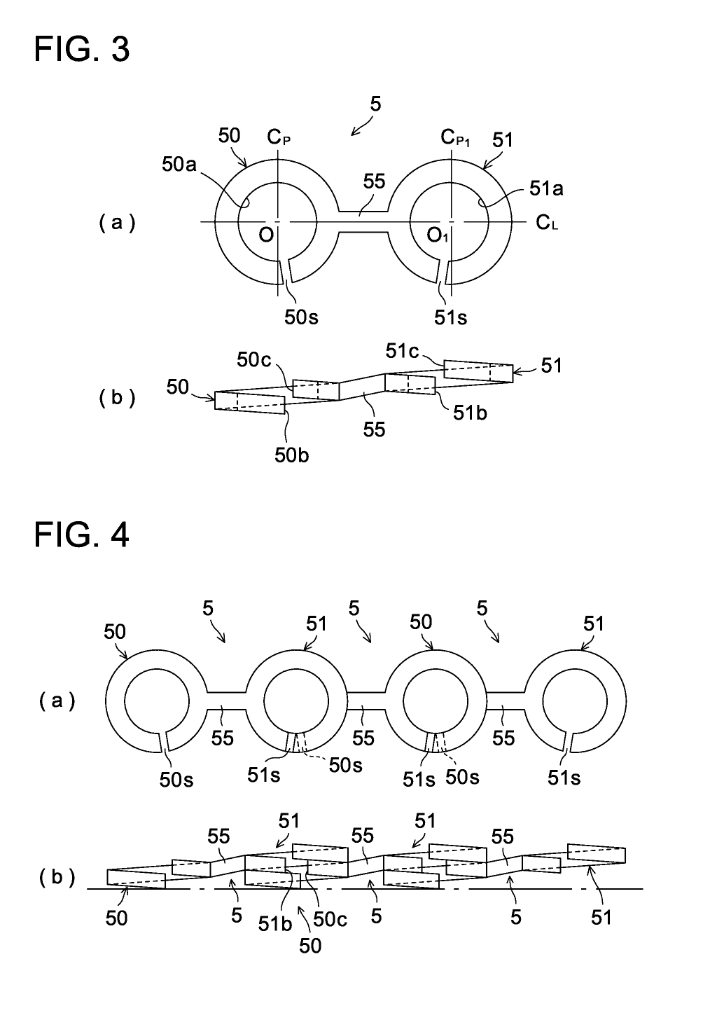

As shown in FIG. 3, the spring washer part 50 of the spring washer structure 5 has a through-hole 50a, and the spring washer part 51 thereof has a through-hole 51a, the linking pins 3 being inserted into these through-holes 50a, 51a. The spring washer parts 50, 51 are formed as coil shapes twisted by one turn, and slits 50s, 51s are formed between starting edges 50b, 51b and ending edges 50c, 51c of said twisted coil shapes of the spring washer parts 50, 51. Furthermore, when the spring washer parts 50, 51 are disposed with the slits 50s, 51s at the front, the end parts on the right-hand side, i.e. the ending edges 50c, 51c, are disposed above the starting edges 50b, 51b.

Furthermore, the spring washer structures 5 are linked by means of the linking parts 55 in a state in which the spring washer parts 50, 51 are disposed with a difference in level in the axial direction (the vertical direction in FIG. 3(b)). Here, the spring washer part 51 of the spring washer structures 5 is disposed at a position above the spring washer part 50. This means that when the spring washer part 50 of the spring washer structure 5 adjacent in the chain length direction to another spring washer structure 5 is disposed below the spring washer part 51 of that other spring washer structure 5 (see FIG. 2), the thickness of the spring washer structures 5 can be reduced, and the spring washer parts 50, 51 can be reliably brought into contact with the adjacent link plates 2 in the chain width direction (see FIG. 2).

As shown in FIG. 4(b), when the spring washer structures 5 extend in the chain length direction, the starting edge 51b of the spring washer part 51 of the spring washer structure 5 is disposed opposite the ending edge 50c of the spring washer part 50 which is overlapped by said spring washer part 51. This means that the thickness of the overlapping portion of the spring washer parts 50, 51 can be reduced, and as a result, it is possible to restrict increases in the chain width caused by assembling the spring washer structures 5 therewith.

As shown in FIG. 3(a), the positions where the slits 50s, 51s of the spring washer parts 50, 51 are formed are offset from straight lines C_{P}, C_{P1} which are orthogonal to the center line C_{L} linking the centers O, O₁ of each of the spring washer parts 50, 51 and which pass through the centers O, O₁ thereof. In this example, the position of the slit 50s in the spring washer part 50 lies offset from the position of the straight line C_{P} toward the spring washer part 51, and the position of the slit 51s in the spring washer part 51 likewise lies offset from the position of the center line C_{P1} toward the spring washer part 50.

By means of this, when the chain extends in a straight line so that the spring washer structures 5 extend in a straight line in the chain length direction, as shown in FIG. 4(a), the slits 50s, 51s of the overlapping spring washer parts 50, 51 may be offset from each other. As a result, and as will be described later, when the link plates 2 flex toward both the sprocket meshing side and the backbend side, the spring washer parts 50, 51 can smoothly mutually rotate toward either side, and it is possible to prevent any impediment to the flexing of the link plates 2.

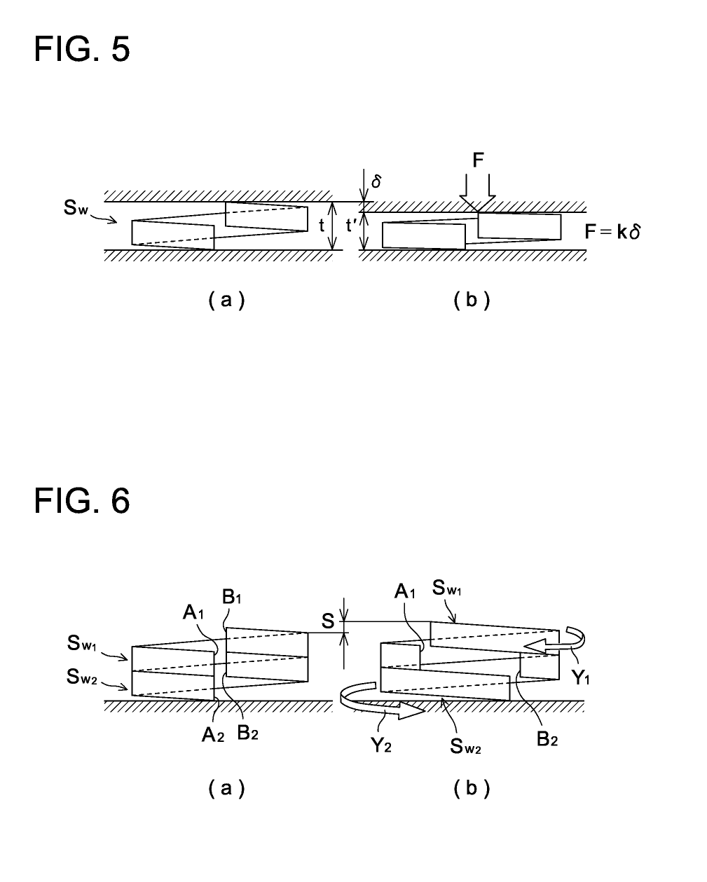

The function of the spring washers which are generally well known as mechanical components will be described next with the aid of FIG. 5. FIG. 5(a) shows the state of a spring washer S_{W} before loading, while FIG. 5(b) shows a state in which a compressive load F is acting on the spring washer S_{W} and the spring washer S_{W} is compressed.

If t is the free length of the spring washer S_{W} before loading, and t′ is the length after loading, then the curvature δ of the spring washer S_{W} is:

δ=t−t′

In this case, if k is the spring constant of the spring washer S_{W}, then the following relation applies to the compressive load F and the curvature δ:

F=k×δ

Conversely, the elastic repelling force accompanying the compressive deformation of the curvature δ of the spring washer S_{W} at this time acts with the same magnitude as the compressive load F in the opposite direction to the direction of action of the compressive load F.

The behavior in the case of an assembly in which two spring washers S_{W} are stacked, as shown in FIG. 6, will be discussed next.

As shown in FIG. 6(a), starting edges A₁, A₂ of two spring washers S_{W1}, S_{W2}, respectively, are aligned and the ending edges B₁, B₂ are aligned. At this point, the starting edge A₁ of the spring washer S_{W1} and the ending edge B₂ of the spring washer S_{W2} are disposed opposite each other with a fixed gap therebetween (the slit width).

As shown in FIG. 6(b), the spring washers S_{W1}, S_{w2} are caused to rotate, from the above state, in such a way that the starting edge A₁ of the spring washer S_{W1} and the ending edge B₂ of the spring washer S_{W2} move apart from each other. That is to say, the spring washer S_{W1} is made to rotate through a specific angle in the direction of the arrow Y₁, while the spring washer S_{W2} is made to rotate through a specific angle in the direction of the arrow Y₂. The mutual rotation of the spring washers S_{W1}, S_{W2} causes the height of the spring washers S_{W1}, S_{W2} to exceed the height before rotation by the distance S. This is because the spring washers generally have a coil shape twisted by one turn (i.e. a helical shape), which means that they have a lead (in other words, the distance of advance in the axial direction when one point on the helix has turned once along the line thereof).

Meanwhile, if the spring washers S_{W1}, S_{W2} rotate by a small amount in the opposite directions to the directions of the arrows Y₁, Y₂, respectively, the height of the spring washers S_{W1}, S_{W2} becomes slightly less than the case shown in FIG. 6(a). It should be noted that in this case, the amount by which the spring washers S_{W1}, S_{W2} can rotate in the opposite directions to the arrows Y₁, Y₂, respectively, is not very great because it is limited by the space between the starting edge A₁ of the spring washer S_{W1} and the ending edge B₂ of the spring washer S_{W2} lying opposite.

The spring washer structure according to the present invention utilizes the properties of such spring washers.

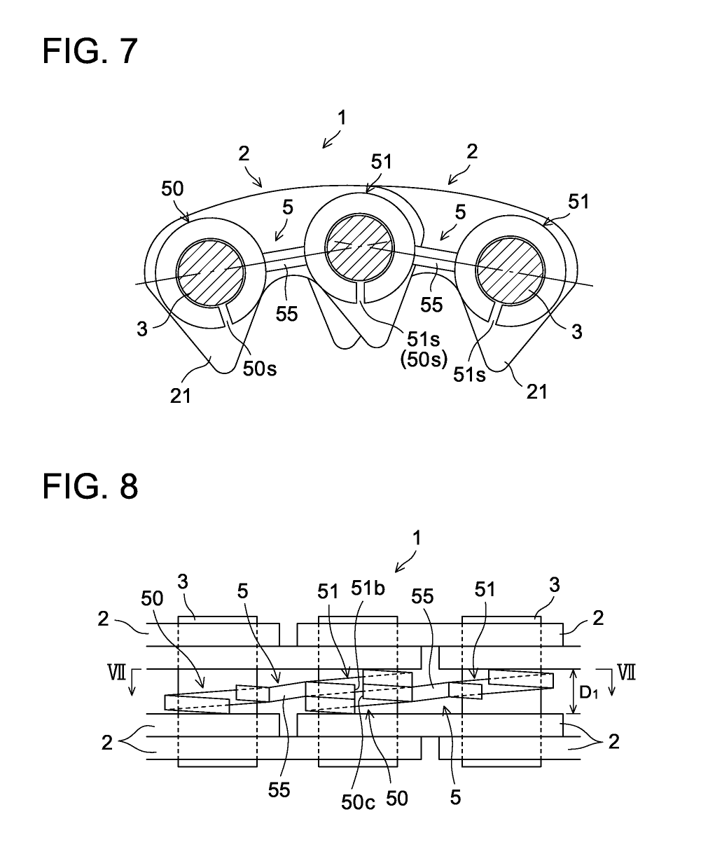

When the link plates 2 flex toward the sprocket meshing side, as shown in FIG. 7 from the state in which the silent chain 1 extends in a straight line, as shown in FIG. 1, the spring washer structures 5 into which the linking pins 3 are inserted also flex in the same direction. At this point, the overlapping spring washer parts 50, 51 of the spring washer structures 5 mutually rotate, and the space between the starting edge 51b of the spring washer part 51 and the ending edge 50c of the spring washer part 50 grows smaller (see FIGS. 2 and 8), so that the slits 50s, 51s of the spring washer parts 50, 51 reach a state of alignment with each other, for example (see FIG. 8).

At this point, as described in paragraph [0051] above, the thickness of the overlapping portions of the spring washer parts 50, 51 becomes smaller than in the case shown in FIG. 2. That is to say, as shown in FIG. 8, if D₁ is the thickness of the overlapping portions of the spring washer parts 50, 51, then:

D₁<D₀

Consequently, when the silent chain 1 meshes, there is no increase in the bending resistance of the silent chain 1 and no reduction in power transmission efficiency when the chain is operating.

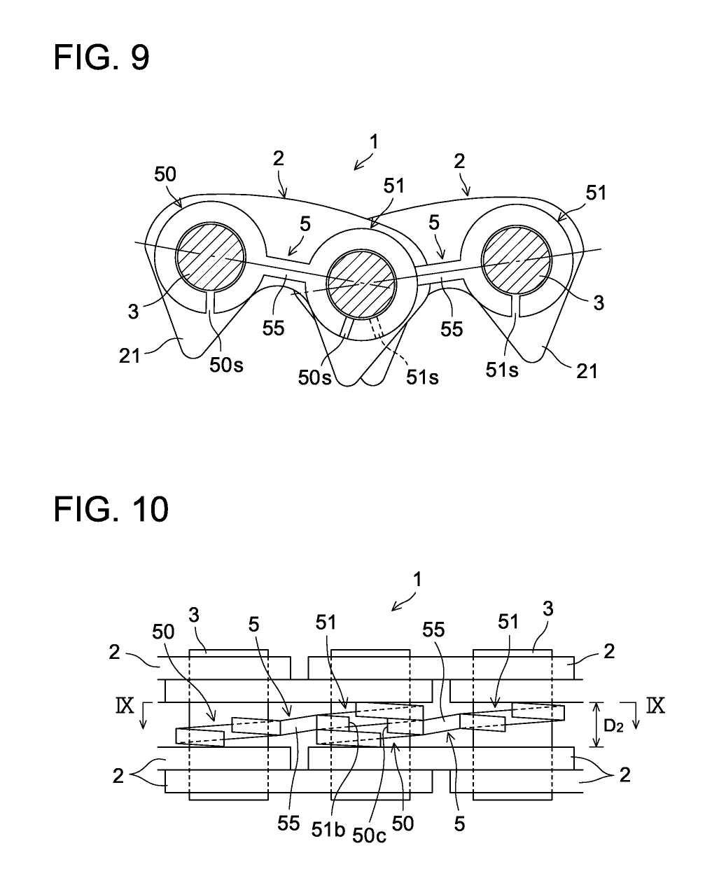

If the link plates 2 then undergo backbend which is the opposite way to what is shown in FIG. 7, the spring washer structures 5 into which the linking pins 3 are inserted also bend back, as shown in FIG. 9. At this point, the overlapping spring washer parts 50, 51 of the spring washer structures 5 mutually rotate, and the space between the starting edge 51b of the spring washer part 51 and the ending edge 50c of the spring washer part 50 grows larger (see FIGS. 2 and 10), whereby the thickness of the overlapping portions of the spring washer parts 50, 51 increases (see FIG. 6).

That is to say, as shown in FIG. 10, if D₂ is the thickness of the overlapping portions of the spring washer parts 50, 51, then:

D₂>D₀

This increase in the thickness of the overlapping portions of the spring washer parts 50, 51 causes a friction force to be applied between adjacent link plates 2 in the chain width direction within the silent chain 1, and by means of this, the bending resistance of the silent chain 1 is increased, backbend of the link plates 2 can be suppressed, and as a result, string vibration in the chain spans can be suppressed.

Moreover, in this case, even if the friction between the linking pins 3 and pin holes 20 causes elongation of the silent chain 1 during operation, the linking pins 3 are always inserted in the spring washer parts 50, 51 of the spring washer structures 5, and the overlapping spring washer parts 50, 51 of adjacent spring washer structures 5 in the chain length direction always mutually rotate together with the link plates 2 when said link plates 2 undergo backbend, thereby causing an increase in the thickness of the spring washer parts 50, 51.

Consequently, the backbend prevention mechanism according to this exemplary embodiment is unaffected by friction in the silent chain 1, and is very durable.

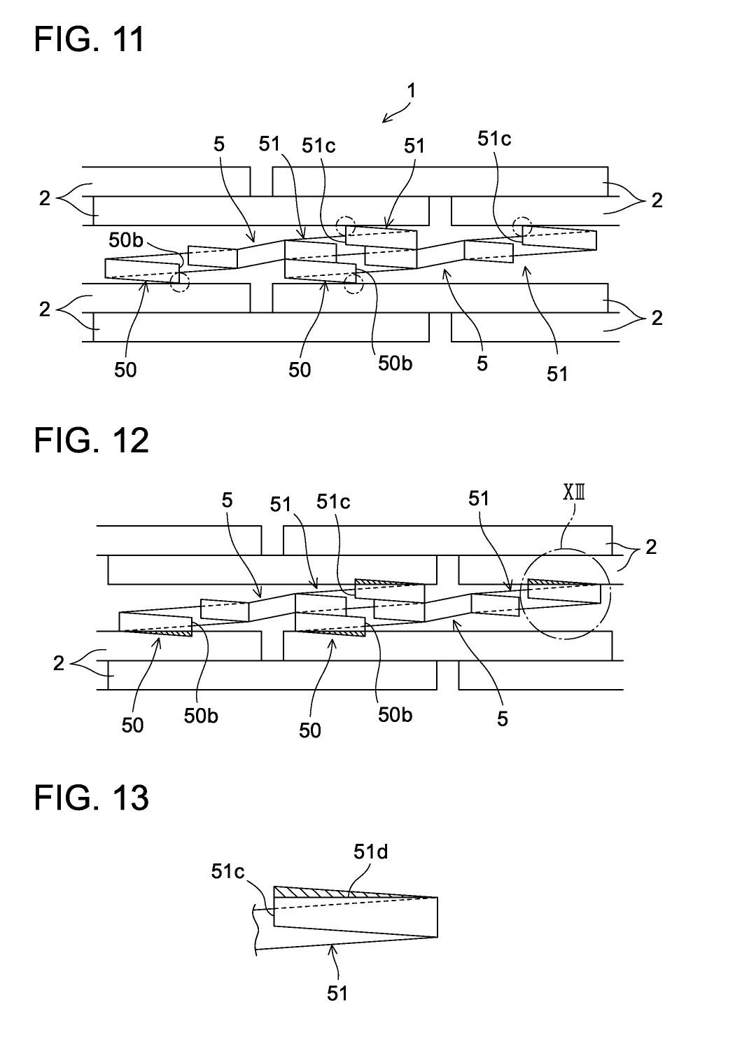

An improved example of the above exemplary embodiment will be described next with the aid of FIGS. 11 to 13. It should be noted that in these figures, components which are the same as or correspond to components in the above exemplary embodiment bear the same reference numbers.

In the above exemplary embodiment, when the link plates 2 undergo backbend, the thickness of the overlapping portions of the spring washer parts 50, 51 of the spring washer structures 5 increases, whereby the edge section of the starting edge 50b of the spring washer part 50 presses against the link plate 2 below in the figure, as shown in FIG. 11, while the edge section of the ending edge 51c of the spring washer part 51 presses against the link plate 2 above in the figure. Consequently, these edge sections are likely to be worn.

In the improved example shown in FIG. 12, oblique regions on the edge section of the starting edge 50b of the spring washer part 50 and on the edge section of the ending edge 51c of the spring washer part 51 are cut away. By means of this, an upper surface 51d which has been cut away on the spring washer part 51, for example, is substantially parallel with the surface of the link plate 2 against which it presses, as shown in FIG. 13. A lower surface which has been cut away on the spring washer part 50 is likewise substantially parallel with the upper surface of the link plate 2 against which it presses.

By means of this, when the link plates 2 undergo backbend, the edge section of the starting edge 50b of the spring washer part 50 and the edge section of the ending edge 51c no longer press against the link plates 2, and as a result it is possible to reduce wear on the spring washer parts 50, 51, and it is possible to further improve the durability of the spring washer structures 5. Furthermore, in this case, cutting away of the oblique regions makes it possible to reduce the overall thickness of the spring washer structure.

It should be noted that examples have been presented in the above exemplary embodiments in which, when the slits 50s, 51s in the spring washer parts 50, 51 of the spring washer structure 5 are disposed at the front, the ending edges 50c, 51c are disposed above the starting edges 50b, 51b, but this is not limiting for the purposes of the present invention.

In the opposite way to the above exemplary embodiments, it is equally feasible, when the slits 50s, 51s in the spring washer parts 50, 51 are disposed at the front, for the starting edges 50b, 51b to be disposed above the ending edges 50c, 51c. Furthermore, in this case, the spring washer part 50 of the spring washer structure 5 is disposed in a position above the spring washer part 51.

By virtue of this configuration, when the link plates 2 flex toward the sprocket meshing side, the mutual rotation of the spring washer parts 50, 51 causes a reduction in the thickness of the overlapping portions of the spring washer parts 50, 51; when the link plates 2 undergo backbend, the mutual rotation of the spring washer parts 50, 51 causes an increase in the thickness of the overlapping portions of the spring washer parts 50, 51, thereby increasing the bending resistance of the silent chain 1 so that it is possible to suppress backbend of the link plates 2.

Furthermore, examples have been described in the above exemplary embodiments in which round pins having a circular cross section are used as the linking pins of the silent chain, but the linking pins of the silent chain according to the present invention may be rocker joints comprising a pair consisting of a long and short joint pin and rocker pin.

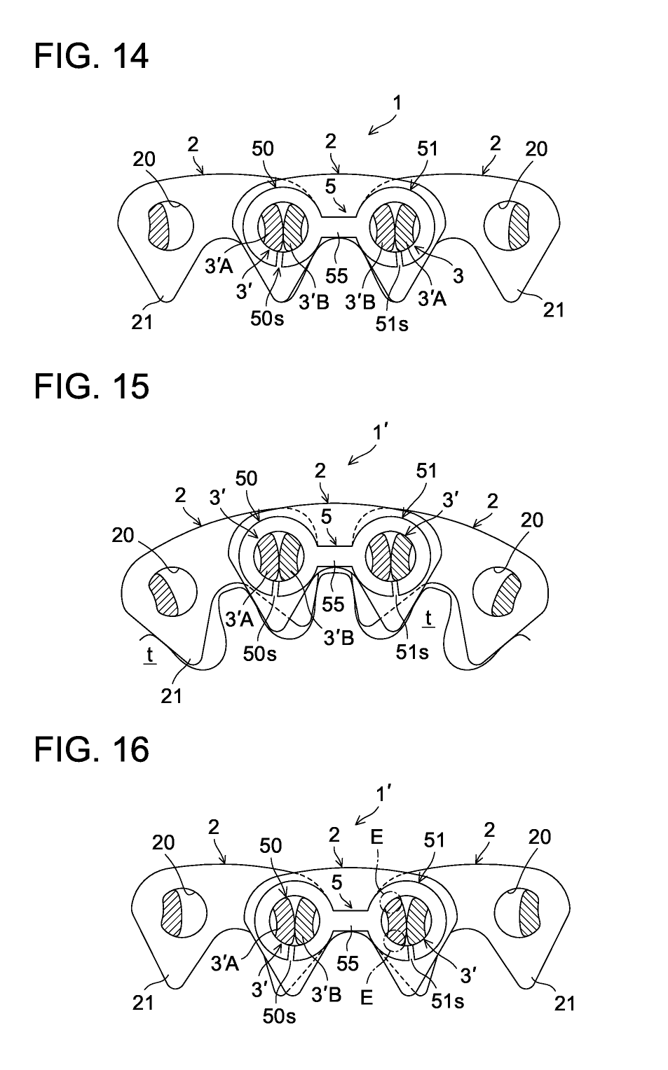

FIGS. 14 to 16 show this kind of rocker joint-type silent chain. FIG. 14 shows a state in which the silent chain extends in a straight line; FIG. 15 shows a state in which the link plates of the silent chain are flexed toward the sprocket meshing side; and FIG. 16 shows a state in which the link plates of the silent chain have undergone backbend. It should be noted that components in these figures which are the same as or correspond to components in the exemplary embodiments described above bear the same reference symbols. It should also be noted that only part of the spring washer structure is shown in this instance.

The link plates 2 of the silent chain 1 can flex by means of rocker joints 3′ comprising a pair consisting of a long and short joint pin 3′A and a rocker pin 3′B. When the link plates 2 flex, the joint pin 3′A and the rocker pin 3′B roll over the rolling face of the other pin, whereby the link plates 2 flex smoothly.

Moreover, in this case, the shape of the rocker joints 3′ and (or) the shape of the through-holes in the spring washer parts are (is) designed in such a way that when the link plates 2 undergo backbend, the rocker pins 3′B of the rocker joints 3′ press against the inner peripheral surface of the pin holes 20, causing interference, as shown by the area E in FIG. 16, and by means of this, backbend of the link plates 2 can be suppressed.

In this case, backbend of the link plates 2 is not only suppressed by the spring washer structures 5, but also by the rocker joints 3′ and pin holes 20, and therefore backbend can be more reliably suppressed.

Examples have been described in the above exemplary embodiments in which the chain used in the present invention is a silent chain, but the present invention may equally be applied to a roller chain or a bush chain.

### FIELD OF INDUSTRIAL APPLICATION

The present invention is applicable to power transmission chains and timing chains such as silent chains, roller chains, and bush chains, and it is especially applicable when there is a requirement for these chains to have a very durable backbend prevention mechanism which makes it possible to suppress string vibration in the chain spans, without reducing the power transmission efficiency during operation.

### KEY TO SYMBOLS

1: silent chain
2: link plate
20: pin hole
3: linking pin (round pin)
3′: linking pin (rocker joint)
3′A: joint pin
3′B: rocker pin
5: spring washer structure
50, 51: spring washer part
50b, 51b: starting edge
50c, 51c: ending: edge
50s, 51s: slit
55: linking bar (linking part)

### Prior Art Documents

Lx

### Patent Documents

[Patent Document 1] Japanese Unexamined Patent Application Publication H8-74939 (see FIGS. 2 and 4)
[Patent Document 2] Japanese Unexamined Patent Application Publication H10-54445 (see FIG. 2)
[Patent Document 3] Japanese Unexamined Patent Application Publication 2000-130518 (see FIGS. 1, 4, and 8)
[Patent Document 4] Japanese Unexamined Patent Application Publication 2004-28154 (see FIGS. 2, 5, and 6)

1. A chain in which a plurality of links having respective pairs of pin holes are disposed in the length direction and the thickness direction, and the links are linked in such a way as to be able to flex about one another by linking pins which are inserted into the pin holes, wherein
a mechanism for preventing backbend is provided between any adjacent links in the thickness direction,
the backbend prevention mechanism is provided, in the chain length direction, with a plurality of spring washer structures consisting of a pair of left-right spring washer parts which are disposed with an interval therebetween and have the linking pins inserted therein, and linking parts for linking the areas between the spring washer parts; and adjacent spring washer structures in the chain length direction extend in the length direction of the chain in a state in which the spring washer parts of each are overlapping, and
when the links undergo backbend, the spring washer structures which are adjacent in the chain length direction and have one overlapping spring washer part flex together with the links, and at this point the mutual rotation of the overlapping spring washer parts causes an increase in the thickness of the overlapping portions of the spring washer parts.

2. The chain as claimed in claim 1, wherein the spring washer parts are formed as coil shapes twisted by one turn, and a slit is formed between the starting edge and ending edge of said twisted coil shapes of the spring washer parts.

3. The chain as claimed in claim 2, wherein the starting edge of one of the overlapping spring washer parts is disposed opposite the ending edge of the other spring washer part.

4. The chain as claimed in claim 2, wherein the position of the slits is offset from a straight line which is orthogonal to the center line linking the centers of each of the spring washer parts and which passes through the centers thereof.

5. The chain as claimed in claim 2, wherein the slit in one of the overlapping spring washer parts is offset from the slit in the other spring washer part.

6. The chain as claimed in claim 1, wherein the spring washer structures are linked by means of the linking parts in a state in which the spring washer parts are disposed with a difference in level in the axial direction.

7. The chain as claimed in claim 6, wherein the adjacent spring washer structures in the chain length direction are such that the spring washer part in the upper position of one of the spring washer structures is disposed above the spring washer part in the lower position of the other spring washer structure.

8. The chain as claimed in claim 1, wherein the linking pins are round pins.

9. The chain as claimed in claim 1, wherein the linking pins are rocker joints comprising a pair consisting of a long and short joint pin and rocker pin, and when the links undergo backbend, the rocker joints press against the inner peripheral surface of the pin hole, providing interference, in order to suppress backbend of the links.

10. The chain as claimed in claim 1, which is a silent chain.

11. The chain as claimed in claim 1, which is a roller chain or a bush chain.
